(19) United States
(12) Patent Application Publication
(10) Pub. No.: US 2012/0233627 A1
(43) Pub. Date: Sep. 13, 2012

(54) METHODS FOR HANDLING TRANSACTION EXECUTION FOR SOFTWARE AND APPLICATION CONTROL MANAGEMENT OBJECT

(76) Inventors: Chun-Ta YU, Taoyuan County (TW); Yin-Yeh Tseng, Taoyuan County (TW)

(21) Appl. No.: 13/412,162

(22) Filed: Mar. 5, 2012

Related U.S. Application Data
(60) Provisional application No. 61/449,907, filed on Mar. 7, 2011.

(51) Int. Cl. G06F 9/46

(52) U.S. Cl. 719/313; 719/328

(57) ABSTRACT

An electronic device, configured as a Software and Application Control Management Object (SACMO) client, is provided with first processor logic and second processor logic. The first processor logic is configured for, in response to executing a transaction of a management object defined for SACMO, determining whether a first workflow to be executed in the transaction exists. The second processor logic is configured for not executing the first workflow in response to the first workflow not existing.

### CROSS REFERENCE TO RELATED APPLICATIONS

This Application claims priority of U.S. Provisional Application No. 61/449,907, filed on Mar. 7, 2011, and the entirety of which is incorporated by reference herein.

### BACKGROUND OF THE INVENTION

1. Field of the Invention

The invention generally relates to transaction execution for Software and Application Control Management Object (SACMO), and more particularly, to handling transaction execution for SACMO by checking the existence of the workflow(s) and/or process(es) of the target transaction during the execution of the target transaction.

2. Description of the Related Art

The Open Mobile Alliance (OMA) was formed in June 2002 by nearly 200 companies representing the world's leading corporations in various fields of the mobile industry, including mobile operators, device and network suppliers, information technology companies, and content/service providers, with an aim to develop open standards for providing interoperable service enablers working across countries, operators and mobile devices in the mobile phone industry. The OMA Device Management (DM) is the international de facto standard for electronic device (e.g., a mobile phone, Personal Digital Assistant (PDA), or palm top computer) management. Device management may involve configuration of the device, such as enabling/disabling certain features of the device, and changing the settings and parameters of the device, etc., software upgrades of the device, such as providing new software and/or bug fixes to be loaded on the device, and fault control of the device, such as error reports from the device, and queries about the status of the device, etc. In the OMA DM working group, Software and Application Control Management Object (SACMO) has been proposed to enable remote operations for software and application control in electronic devices. Specifically, the SACMO specifications provide the capability to process management workflows that enable on-device management of software and applications utilizing existing management objects or applications that could be a native executable application or a script either in the electronic device or remote server, whereby any combination of operations on the existing management object can be applied and conditionally executed.

In a general SACMO architectural model, a SACMO client configured on the electronic device is responsible for executing the SACMO operations issued by a SACMO server or in request of the SACMO server. When executing a transaction of a management object defined for SACMO or executing a step of a transaction of a management object defined for SACMO, the SACMO client first executes the workflow indicated by the ExecWorkflowID node in the Transaction sub-tree or the process indicated by the ExecProcessID node in the Workflow sub-tree of the management object. However, the indicated workflow or process may not exist because the SACMO server may mistakenly remove the workflow or process since the transactions, workflows, and processes are created and maintained separately in the management object, or because of a system crash of the electronic device which damages the content of the management object.

### BRIEF SUMMARY OF THE INVENTION

Thus, the invention proposes a protection mechanism for the SACMO client to check the existence of the target workflow(s) and/or process(es) during transaction execution, so that the SACMO client may correctly process the SACMO operations.

In a first aspect of the invention, a method for handling transaction execution for SACMO is provided. The method comprises the steps of determining, by a SACMO client, whether a first workflow to be executed in a transaction of a Management Object defined for SACMO exists, in response to executing the transaction, and not executing, by the SACMO client, the first workflow in response to the first workflow not existing.

In a second aspect of the invention, an electronic device, configured as a Software and Application Control Management Object (SACMO) client is provided. The electronic device comprises first processor logic and second processor logic. The first processor logic is configured for, in response to executing a step of a transaction of a management object defined for SACMO, determining whether a process to be executed in the step exists. The second processor logic is configured for not executing the process in response to the process not existing.

In a third aspect of the invention, a method for handling step execution in a transaction for SACMO is provided. The method comprises the steps of determining, by a SACMO client, whether a process to be executed in a step of the transaction of a management object defined for SACMO exists, in response to executing the step, and not executing, by the SACMO client, the process in response to the process not existing.

Other aspects and features of the present invention will become apparent to those with ordinarily skill in the art upon review of the following descriptions of specific embodiments of apparatuses and methods for handling transaction/step execution for SACMO.

### BRIEF DESCRIPTION OF DRAWINGS

The invention can be more fully understood by reading the subsequent detailed description and examples with references made to the accompanying drawings, wherein:

FIG. 1 is a block diagram illustrating a SACMO architectural model according to an embodiment of the invention;

FIG. 2 is a schematic diagram illustrating an exemplary relationship of Process, Step and Workflow;

FIGS. 3A to 3C show a schematic diagram illustrating the tree structure of a management object defined for SACMO according to an embodiment of the invention;

FIG. 4 is a message sequence chart illustrating the handling of a transaction execution for SACMO according to an embodiment of the invention;

FIG. 5 is a message sequence chart illustrating the handling of a transaction execution for SACMO according to another embodiment of the invention;

FIG. 6 is a message sequence chart illustrating the handling of a step execution in a transaction for SACMO according to an embodiment of the invention;

FIG. 7 is a message sequence chart illustrating the handling of a step execution in a transaction for SACMO according to another embodiment of the invention;

FIG. 8 is a flow chart illustrating the method for handling a transaction execution for SACMO according to an embodiment of the invention; and

FIG. 9 is a flow chart illustrating the method for handling a step execution in a transaction for SACMO according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. Note that the OMA specifications described herein are used to teach the spirit of the invention, and the invention is not limited thereto.

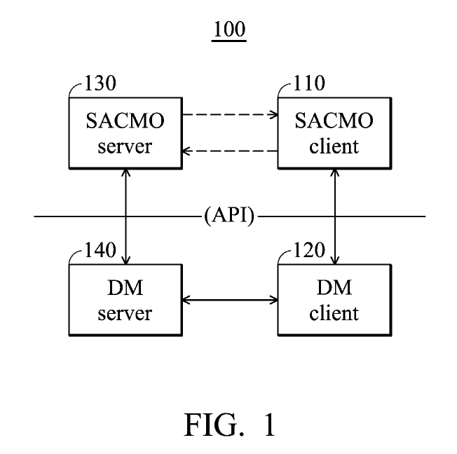

FIG. 1 is a block diagram illustrating a SACMO architectural model according to an embodiment of the invention. In the SACMO architectural model 100, the SACMO client 110 is a logical entity which is responsible for executing SACMO operations, and the SACMO server 130 is a logical entity which is dedicated to issue the SACMO operations to the SACMO client 110 or receive responses from the SACMO client 110, wherein the communications between the SACMO client 110 and the SACMO server 130 (denoted with dotted arrows in FIG. 1) are carried out by the DM client 120 and DM server 140 via the Application Programming Interfaces (API). The DM client 120 and the DM server 140 are two logical entities which provide a communication interface between the SACMO client 110 and the SACMO server 130 in compliance with the DM protocol. For example, the SACMO server 130 may invoke SACMO operations on the electronic device where the SACMO client 110 is configured using the DM interface provided by the DM server 140 and the DM client 120, and the SACMO client 110 may send responses to the SACMO server 130 using the DM interface provided by the DM server 140 and the DM client 120. Specifically, the SACMO client 110 and the DM client 120 may be two components incorporated into an electronic device, such as a mobile phone, Personal Digital Assistant (PDA), or palm top computer, and enabled by a general-purpose processor or a Micro-Control Unit (MCU) of the electronic device. Similarly, the SACMO server 130 and DM server 140 may be two components incorporated into a remote server setup by operators, network suppliers, information technology companies, or content/service providers, and enabled by a general-purpose processor or an MCU of the remote server. Note that the general-purpose processors or MCUs of the electronic device and the remote server may each comprise processor logic for performing the described tasks for the SACMO client 110 and the SACMO server 130, and for performing the method for handling transaction execution for SACMO as proposed in the invention. If the electronic device is capable of wireless communications, it may further comprise a baseband unit and a radio frequency (RF) unit for baseband signal processing and RF wireless signals transmission/reception, respectively, and/or other functional components, such as a display unit and/or keypad serving as the MMI (man-machine interface), a storage unit storing the program codes of SACMO and DM protocols and the communication protocol according to the Radio Access Technology (RAT) in use, or others.

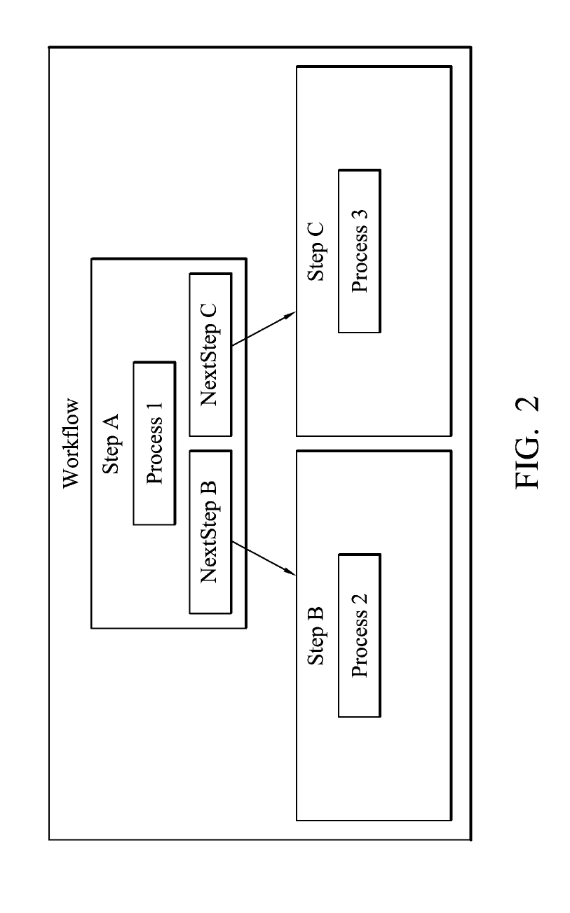

In the SACMO framework, four SACMO components, including Transaction, Workflow, Step, and Process, are introduced. A Transaction is an instance of a Workflow execution, wherein a Workflow is a sequence of Step(s) which is conditionally executed. Specifically, the SACMO server 130 may deliver a Workflow to the SACMO client 110, and the SACMO client 110 may execute the Workflow which in turn creates a Transaction. A Step is a basic unit of a Workflow, which consists of a Process and information for the next Step(s), and a Process is a basic unit for a specific SACMO operation execution. In addition, a Process can be reused in multiple Workflows. FIG. 2 is a schematic diagram illustrating an exemplary relationship of Process, Step and Workflow. As shown in FIG. 2, the Workflow comprises three Steps, i.e., the Steps A, B, and C. The Step A indicates the Process 1 and two subsequent Steps B and C, wherein the Step B indicates the Process 2 and the Step C indicates the Process 3.

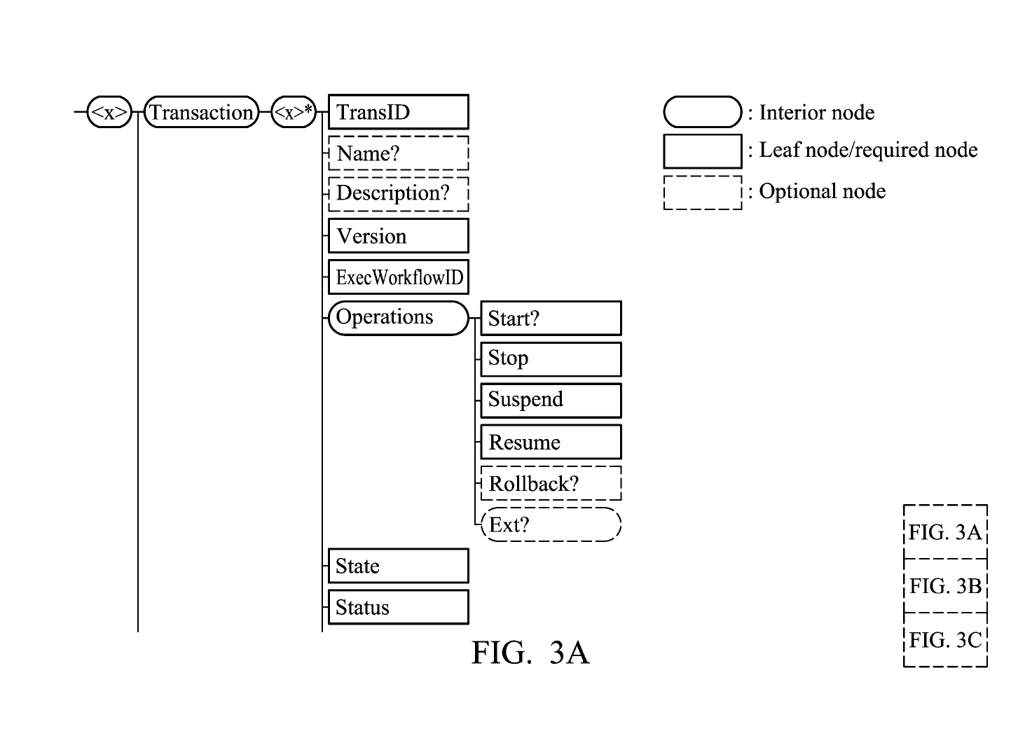

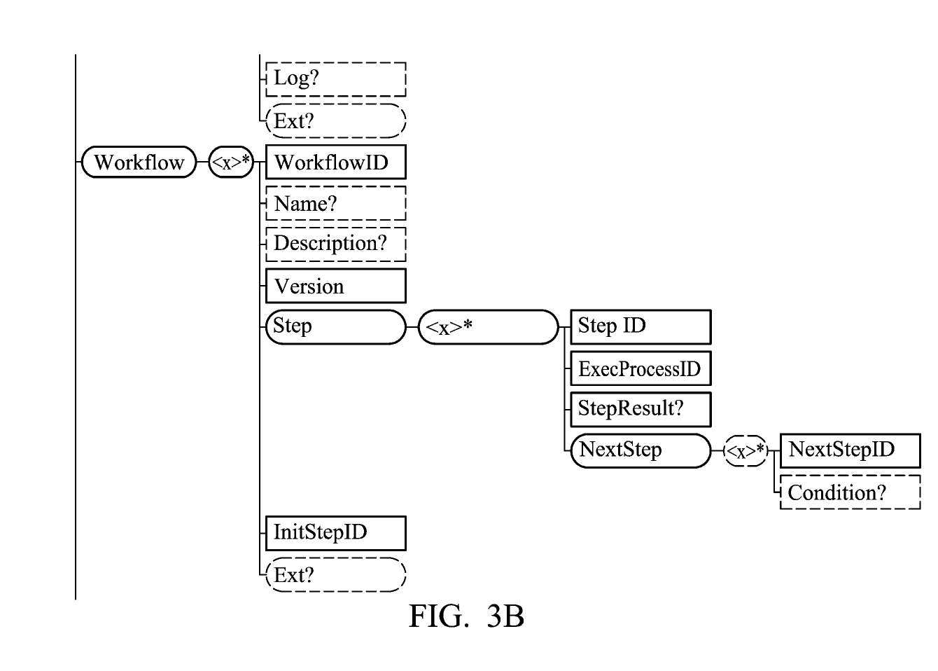

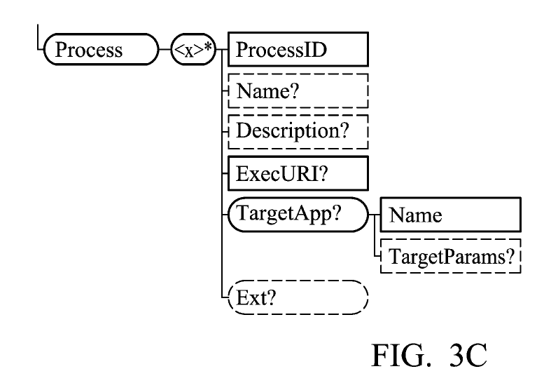

FIGS. 3A to 3C show a schematic diagram illustrating the tree structure of a management object defined for SACMO according to an embodiment of the invention. As shown in FIG. 3A, the SACMO tree is assembled under an unnamed interior node x, which is dynamically or statically created. The Transaction node groups together all of the transactions of the management object, and the Transaction/<x> node groups the information of one transaction, such as the identifier of the transaction (denoted as TransID), the name of the transaction (denoted as Name), the description of the transaction (denoted as Description), the version of the transaction (denoted as Version), the workflow to be executed (denoted as ExecWorkflowID), and the status of the transaction (denoted as Status), etc. For example, the SACMO server 130 may further retrieve the status of the transaction execution from the Transaction/<x>/Status.

The Workflow node groups together all of the workflows of the management object, and the Workflow/<x> node groups the information of one workflow, such as the identifier of the workflow (denoted as WorkflowID), the name of the workflow (denoted as Name), the description of the workflow (denoted as Description), the version of the workflow (denoted as Version), the steps to be executed (denoted as Step), and the first step in the workflow (denoted as InitStepID), etc. For example, the SACMO server 130 may download a Workflow with a unique WorkflowID and an InitStepID to the SACMO client 110.

The Step node groups together all of the steps of the management object, and the Workflowk×>/Step<x> node groups the information of one or more steps, such as the identifier of the step (denoted as StepID), the identifier of the process to be executed (denoted as ExecProcessID), the result of the step (denoted as StepResult), and the next step to be executed (denoted as NextStep). The Workflow/<x>/Step/<x>/NextStep node groups the information concerning the next step, such as the identifier of the next step to be executed (denoted as NextStepID), and the condition to the next step to be applied (denoted as Condition). To further clarify, a Step must have a ProcessID to indicate the Process to execute. If a Step is followed by another Step, a NextStep subtree is created. The NextStep subtree may contain multiple next Steps, and each next Step has a NextStepID to indicate the following Step and optionally a condition. The SACMO client 130 may check the condition, and if the condition is passed, the next Step will be executed.

The Process node groups together all of the processes associated with the workflow, and the Process/<x> node groups the information of one or more processes, such as the identifier of the process in the SACMO tree (denoted as ProcessID), the name of the process (denoted as Name), the description of the process (denoted as Description), and the Uniform Resource Identifier (URI) of a node in the SACMO tree, which comprises information associated with the execution of the process (denoted as ExecURI), etc. The Process/<x>/TargetApp node groups information that is used for executing an application which can be accessed by the SACMO client 110.

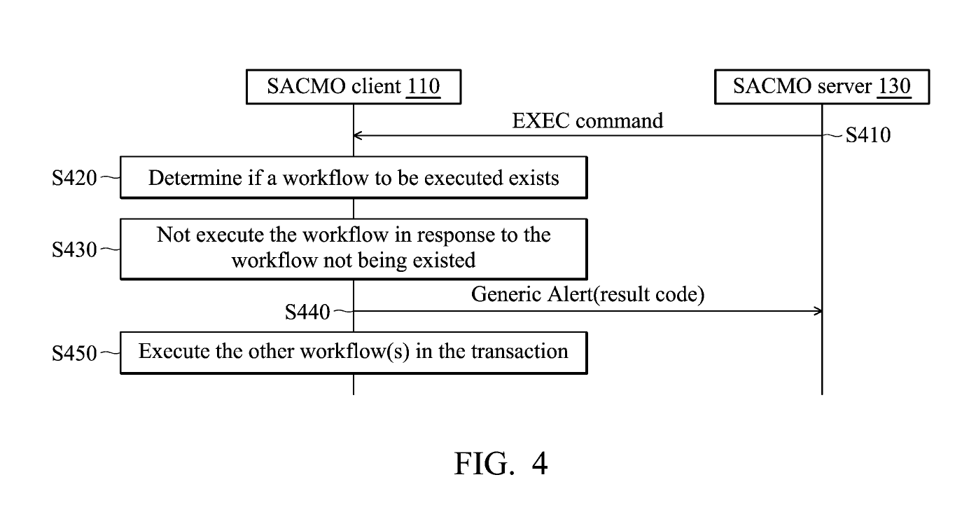

FIG. 4 is a message sequence chart illustrating the handling of a transaction execution for SACMO according to an embodiment of the invention. To begin, the SACMO server 130 sends an EXEC command to the SACMO client 110 (step S410), wherein the EXEC command is used to request the SACMO client 110 to execute a specific transaction of a management object defined for SACMO. In one embodiment, the management object defined for SACMO may be delivered to the SACMO client 110 from the SACMO server 130 via another message, prior to the EXEC command being sent. In another embodiment, the management object defined for SACMO may be preconfigured in the electronic device during the manufacturing process of the electronic device. When receiving the EXEC command, the SACMO client 110 starts to execute the transaction by firstly determining whether a workflow to be executed in the transaction exists (step S420). In this embodiment, it is assumed that the workflow does not exist, so the SACMO client 110 does not execute the workflow (step S430). Subsequently, the SACMO client 110 sends a notification with a result code indicating the absence of the workflow to the SACMO server 130 via a Generic Alert message (step S440). After that, the SACMO client 110 continues to execute the other workflow(s) in the transaction (step S450). Note that, in another embodiment, if only one workflow exists in the transaction, the step S450 may be skipped to end the execution of the transaction. It is to be understood that each of the steps S420 to S450 may be performed by respective processor logic in the electronic device where the SACMO client 110 is configured.

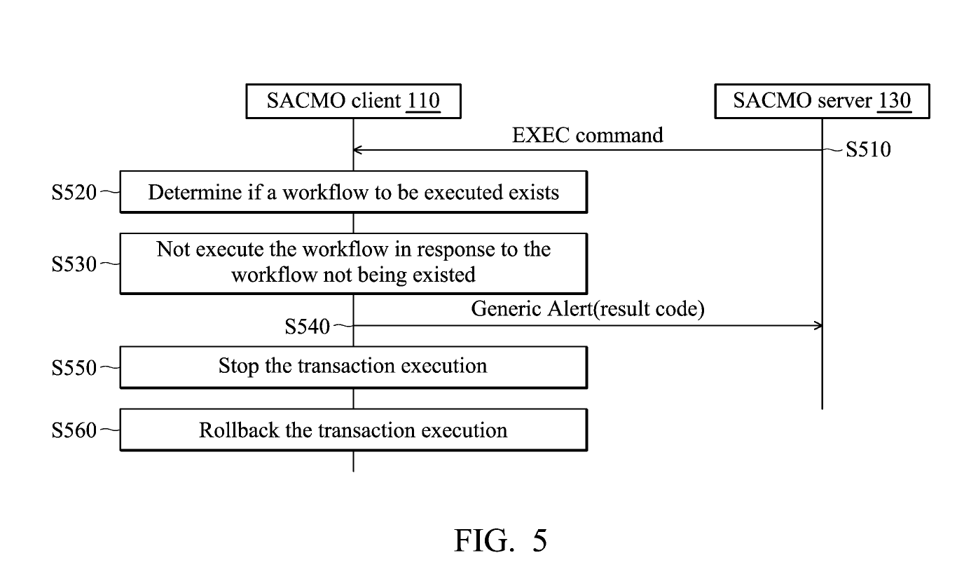

FIG. 5 is a message sequence chart illustrating the handling of a transaction execution for SACMO according to another embodiment of the invention. Similar to FIG. 4, the SACMO server 130 sends an EXEC command to the SACMO client 110 (step S510), wherein the EXEC command is used to request the SACMO client 110 to execute a specific transaction of a management object defined for SACMO. When receiving the EXEC command, the SACMO client 110 starts to execute the transaction by first determining whether a workflow to be executed in the transaction exists (step S520). In this embodiment, it is assumed that the workflow does not exist, so the SACMO client 110 does not execute the workflow (step S530). Subsequently, the SACMO client 110 sends a notification with a result code indicating the absence of the workflow to the SACMO server 130 via a Generic Alert message (step S540). After that, the SACMO client 110 stops the execution of the transaction (step S550), and then performs a rollback operation to undo the execution of the transaction (step S560). That is, the rollback operation aims to recover to the initial state where the transaction is not yet executed. Note that, in another embodiment, the step S560 may be skipped to leave the transaction as it is. It is to be understood that each of the steps S520 to S560 may be performed by respective processor logic in the electronic device where the SACMO client 110 is configured.

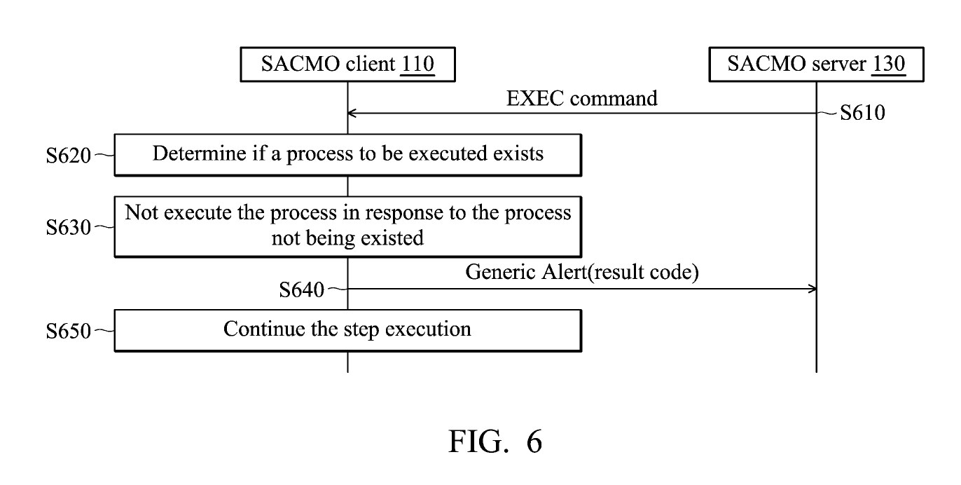

FIG. 6 is a message sequence chart illustrating the handling of a step execution in a transaction for SACMO according to an embodiment of the invention. To begin, the SACMO server 130 sends an EXEC command to the SACMO client 110 (step S610), wherein the EXEC command is used to request the SACMO client 110 to execute a specific transaction of a management object defined for SACMO. In one embodiment, the management object defined for SACMO may be delivered to the SACMO client 110 from the SACMO server 130 via another message, prior to the EXEC command being sent. In another embodiment, the management object defined for SACMO may be preconfigured in the electronic device during the manufacturing process of the electronic device. When receiving the EXEC command, the SACMO client 110 starts to execute the transaction by firstly determining whether a process to be executed in a step of the transaction exists (step S620). In this embodiment, it is assumed that the process does not exist, so the SACMO client 110 does not execute the process (step S630). Subsequently, the SACMO client 110 sends a notification with a result code indicating the absence of the process to the SACMO server 130 via a Generic Alert message (step S640). After that, the SACMO client 110 continues to execute the step (step S650). In other words for the step S650, if there is one or more next steps indicated by the step, the SACMO client 110 continues to execute the process(es) in the next step(s). It is to be understood that each of the steps S620 to S650 may be performed by respective processor logic in the electronic device where the SACMO client 110 is configured.

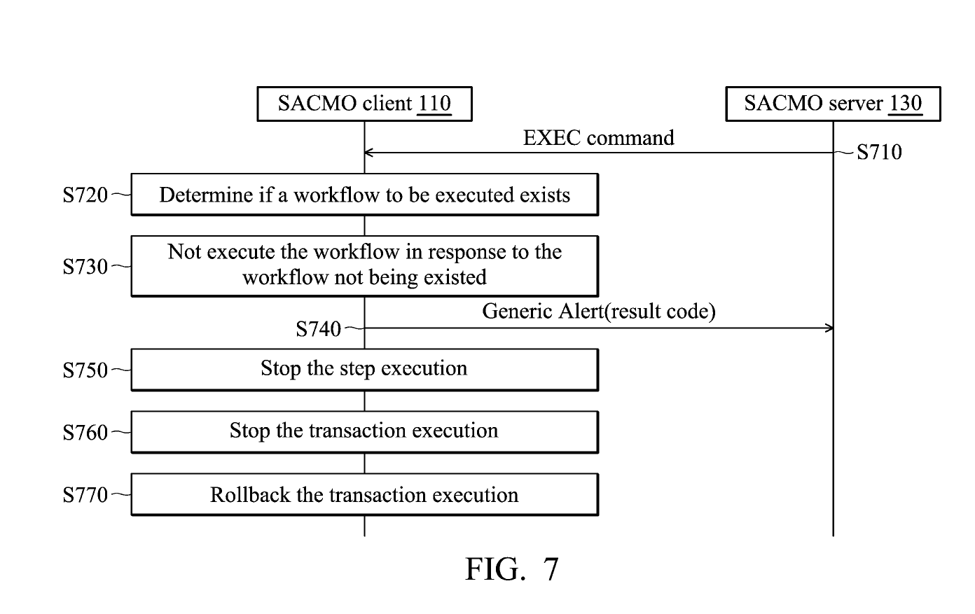

FIG. 7 is a message sequence chart illustrating the handling of a step execution in a transaction for SACMO according to another embodiment of the invention. Similar to FIG. 6, the SACMO server 130 sends an EXEC command to the SACMO client 110 (step S710), wherein the EXEC command is used to request the SACMO client 110 to execute a specific transaction of a management object defined for SACMO. When receiving the EXEC command, the SACMO client 110 starts to execute the transaction by first determining whether a process to be executed in a step of the transaction exists (step S720). In this embodiment, it is assumed that the process does not exist, so the SACMO client 110 does not execute the process (step S730). Subsequently, the SACMO client 110 sends a notification with a result code indicating the absence of the workflow to the SACMO server 130 via a Generic Alert message (step S740). Next, the SACMO client 110 stops the execution of the step (step S750), and further stops the execution of the transaction (step S760). After that, the SACMO client 110 performs a rollback operation to undo the execution of the transaction (step S770). That is, the rollback operation aims to recover to the initial state where the transaction is not yet executed. Note that, in another embodiment, the step S750 may be skipped to proceed to the step S760 directly, and the step S770 may be skipped to leave the transaction as it is. In yet another embodiment, the step S760 and S770 may be omitted after the step S750. It is to be understood that each of the steps S720 to S770 may be performed by respective processor logic in the electronic device where the SACMO client 110 is configured.

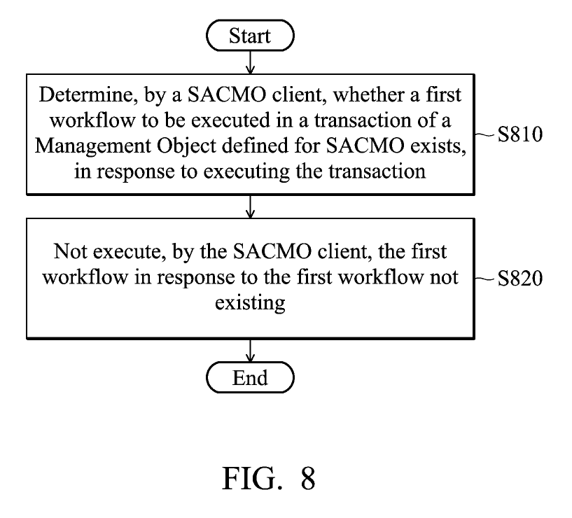

FIG. 8 is a flow chart illustrating the method for handling a transaction execution for SACMO according to an embodiment of the invention. The method may be applied in any electronic device configured as a SACMO client. To begin the method, the SACMO client first determines whether a workflow to be executed in a transaction of a management object defined for SACMO exists, in response to executing the transaction (step S810). The execution of the transaction may be triggered by receiving an EXEC command from the SACMO server. The management object defined for SACMO may be delivered to the SACMO client from a SACMO server, or may be preconfigured in the electronic device during the manufacturing process of the electronic device. Subsequently, the SACMO client does not execute the workflow in response to the workflow not existing (step S820). Thus, the execution of the transaction is protected from errors caused by the absence of workflow to be executed.

In addition, after the step S820, the SACMO client may further send a notification with a result code indicating the absence of the workflow to the SACMO server. In one embodiment, the notification may be delivered via a Generic Alert message. The SACMO client may also determine whether to continue the execution of the transaction, and if so, execute the other workflow(s) in the transaction, and if not, stop the execution of the transaction. In the case of stopping the execution of the transaction, the SACMO client may further perform a rollback operation to undo the execution of the transaction.

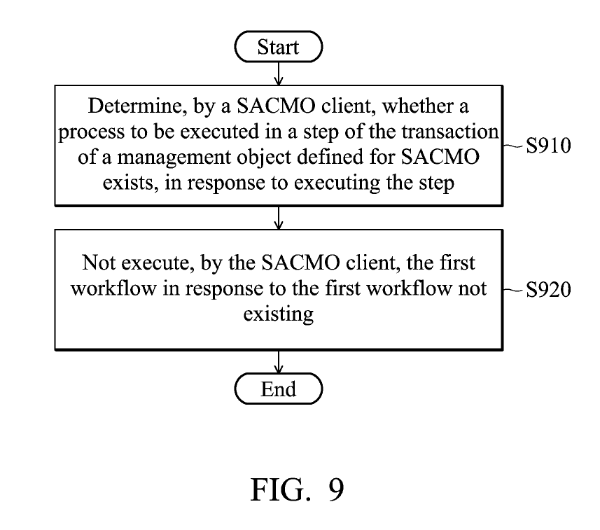

FIG. 9 is a flow chart illustrating the method for handling a step execution in a transaction for SACMO according to an embodiment of the invention. The method may be applied in any electronic device configured as a SACMO client. To begin the method, the SACMO client first determines whether a process to be executed in a step of a transaction of a management object defined for SACMO exists, in response to executing the step (step S910). The SACMO server may send an EXEC command to the SACMO client for executing the transaction, and the transaction execution may further trigger the execution of the step. The management object defined for SACMO may be delivered to the SACMO client from a SACMO server, or may be preconfigured in the electronic device during the manufacturing process of the electronic device. Subsequently, the SACMO client does not execute the process in response to the process not existing (step S920). Thus, the execution of the step is protected from errors caused by the absence of processes to be executed.

In addition, after the step S920, the SACMO client may further send a notification with a result code indicating the absence of the process to the SACMO server. In one embodiment, the notification may be delivered via a Generic Alert message. The SACMO client may also determine whether to continue the execution of the step, and if so, execute the next step(s) indicated in the step, and if not, stop the execution of the step or transaction. In the case of stopping the execution of the transaction, the SACMO client may further perform a rollback operation to undo the execution of the transaction.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A method for handling transaction execution for Software and Application Control Management Object (SACMO), comprising:
determining, by a SACMO client, whether a first workflow to be executed in a transaction of a Management Object defined for SACMO exists, in response to executing the transaction; and
not executing, by the SACMO client, the first workflow in response to the first workflow not existing.

2. The method of claim 1, further comprising executing, by the SACMO client, the first workflow in response to the first workflow existing

3. The method of claim 1, further comprising executing, by the SACMO client, a second workflow to be executed in the transaction in response to the first workflow not existing.

4. The method of claim 1, further comprising stopping, by the SACMO client, the execution of the transaction in response to the first workflow not existing.

5. The method of claim 4, further comprising performing, by the SACMO client, a rollback operation to undo the execution of the transaction.

6. The method of claim 1, further comprising sending, by the SACMO client, a notification with a result code indicating the absence of the first workflow to a SACMO server via a Generic Alert message, in response to the first workflow not existing.

7. An electronic device, configured as a Software and Application Control Management Object (SACMO) client, comprising:
first processor logic for, in response to executing a step of a transaction of a management object defined for SACMO, determining whether a process to be executed in the step exists; and
second processor logic for not executing the process in response to the process not existing.

8. The electronic device of claim 7, further comprising third processor logic for executing the process in response to the process existing.

9. The electronic device of claim 7, further comprising fourth processor logic for continuing the execution of the step in response to the process not existing.

10. The electronic device of claim 7, further comprising fifth processor logic for stopping the execution of the step in response to the process not existing.

11. The electronic device of claim 7, further comprising sixth processor logic for stopping the execution of the transaction in response to the process not existing.

12. The electronic device of claim 11, further comprising seventh processor logic for performing a rollback operation to undo the execution of the transaction.

13. The electronic device of claim 7, further comprising eighth processor logic for sending a notification with a result code indicating the absence of the process to a SACMO server via a Generic Alert message, in response to the process not existing.

14. A method for handling step execution in a transaction for Software and Application Control Management Object (SACMO), comprising:
determining, by a SACMO client, whether a process to be executed in a step of the transaction of a management object defined for SACMO exists, in response to executing the step; and
not executing, by the SACMO client, the process in response to the process not existing.

15. The method of claim 14, further comprising executing, by the SACMO client, the process in response to the process existing.

16. The method of claim 14, further comprising continuing, by the SACMO client, executing the step in response to the process not existing.

17. The method of claim 14, further comprising stopping, by the SACMO client, the execution of the step in response to the process not existing.

18. The method of claim 14, further comprising stopping, by the SACMO client, the execution of the transaction in response to the process not existing.

19. The method of claim 18, further comprising performing, by the SACMO client, a rollback operation to undo the execution of the transaction.

20. The method of claim 14, further comprising sending, by the SACMO client, a notification with a result code indicating the absence of the process to a SACMO server via a Generic Alert message, in response to the process not existing.
